(19) United States
(12) Patent Application Publication
(10) Pub. No.: US 2017/0217445 A1
(43) Pub. Date: Aug. 3, 2017

(54) SYSTEM FOR INTELLIGENT PASSENGER-VEHICLE INTERACTIONS

(71) Applicant: GM Global Technology Operations LLC, Detroit, MI (US)

(72) Inventors: Eli Tzirkel-Hancock, Ra'anana (IL); Ilan Malka, Tel Aviv (IL); Ute Winter, Petach Tiqwa (IL); Scott D. Custer, Lake Orion, MI (US); David P. Pop, Garden City, MI (US)

(21) Appl. No.: 15/159,347

(22) Filed: May 19, 2016

Related U.S. Application Data
(63) Continuation-in-part of application No. 15/011,060, filed on Jan. 29, 2016.

(51) Int. Cl. B60W 50/08; B62D 15/02; B60T 7/12; G05D 1/00; B60W 50/10

(52) U.S. Cl. CPC B60W 50/08; G05D 1/0088; B60W 50/10; B60T 7/12; B62D 15/02

(57) ABSTRACT

Systems and processes for implementation at an autonomous-driving vehicle of transportation. exemplary processes include obtaining, by a tangible human-machine interface, an autonomous-vehicle-passenger communication, and obtaining, by a hardware-based processing unit, context data comprising learned-passenger data based on prior activity of an autonomous-vehicle-passenger. Processes also include determining, based on the autonomous-vehicle-passenger communication and the context data, at least one of (i) an appropriate autonomous-driving function, (ii) appropriate assistance to provide to the autonomous-vehicle-passenger, and (iii) appropriate information to provide to the autonomous-vehicle-passenger.

### CROSS-REFERENCE TO RELATED APPLICATION

The present application is a continuation-in-part application of U.S. patent application Ser. No. 15/011,060, filed Jan. 29, 2016, which is hereby incorporated in its entirety herein.

### TECHNICAL FIELD

The present disclosure relates generally to vehicle systems for interacting efficiently with occupants and, more particularly, to systems for interacting intelligently with autonomous-vehicle passengers.

### BACKGROUND

This section provides background information related to the present disclosure which is not necessarily prior art.

Manufacturers are increasingly producing vehicles having higher levels of driving automation. Features such as adaptive cruise control and lateral positioning have become popular and are precursors to greater adoption of fully autonomous-driving-capable vehicles.

While availability of autonomous-driving-capable vehicles is on the rise, users' familiarity and comfort with autonomous-driving functions will not necessarily keep pace. User comfort with the automation is an important aspect in overall technology adoption and user experience.

Also, with highly automated vehicles expected to be commonplace in the near future, a market for fully-autonomous taxi services and shared vehicles is developing. In addition to becoming familiar with the automated functionality, customers interested in these services will need to become accustomed to be driven by a driverless vehicle that is not theirs, and in some cases along with other passengers, whom they may not know.

Uneasiness with automated-driving functionality, and possibly also with the shared-vehicle experience, can lead to reduced use of the autonomous driving capabilities, such as by the user not engaging, or disengaging, autonomous-driving operation, or not commencing or continuing in a shared-vehicle ride. In some cases, the user continues to use the autonomous functions, whether in a shared vehicle, but with a relatively low level of satisfaction.

An uncomfortable user may also be less likely to order the shared vehicle experience in the first place, or to learn about and use more-advanced autonomous-driving capabilities, whether in a shared ride or otherwise.

Levels of adoption can also affect marketing and sales of autonomous-driving-capable vehicles. As users' trust in autonomous-driving systems and shared-automated vehicles increases, the users are more likely to purchase an autonomous-driving-capable vehicle, schedule an automated taxi, share an automated vehicle, model doing the same for others, or expressly recommend that others do the same.

### SUMMARY

In one aspect, the present technology relates to a process, for implementation at an autonomous-driving vehicle of transportation. The process includes obtaining, by a tangible human-machine interface, an autonomous-vehicle-passenger communication, and obtaining, by a hardware-based processing unit, context data comprising learned-passenger data based on prior activity of an autonomous-vehicle-passenger.

The process also includes determining, by the hardware-based processing unit executing a passenger-communication vehicle-control module, based on the autonomous-vehicle-passenger communication and the context data, an appropriate autonomous-driving function, and performing the autonomous-driving function.

The autonomous-vehicle-passenger communication in various embodiments includes at least one of autonomous-vehicle-passenger speech, an autonomous-vehicle-passenger utterance, and an autonomous-vehicle-passenger gesture.

Performing the autonomous-driving function in various embodiments includes adjusting operation of one or more of a vehicle braking component, a vehicle steering component, and a vehicle throttle component.

The process in various embodiments further includes: obtaining, by the hardware-based processing unit, prior-passenger-activity data indicating the prior activity of the autonomous-vehicle passenger; and generating, by the hardware-based processing unit, based on the prior-passenger-activity data, the learned-passenger data.

The prior-passenger-activity data may indicate any of: (i) autonomous-vehicle-passenger speech sensed at the vehicle in connection with an autonomous-vehicle maneuver performed by the autonomous-driving vehicle on a prior trip; (ii) an autonomous-vehicle-passenger response to an autonomous-vehicle maneuver made by the autonomous-driving vehicle on a prior trip; (iii) an autonomous-vehicle-passenger utterance sensed at the vehicle in connection with an autonomous-vehicle maneuver made by the autonomous-driving vehicle on a prior trip; and (iv) an autonomous-vehicle-passenger gesture sensed in connection with an autonomous-vehicle maneuver performed by the autonomous-driving vehicle on a prior trip.

In another aspect, the disclosure describes a process, for implementation at an autonomous-driving vehicle of transportation, including obtaining, by a tangible human-machine interface, an autonomous-vehicle-passenger communication, and obtaining, by a hardware-based processing unit, context data comprising learned-passenger data based on prior activity of an autonomous-vehicle-passenger.

The process also includes: determining, by the hardware-based processing unit executing a passenger-assistance module, based on the autonomous-vehicle-passenger communication and the context data, appropriate assistance to provide to the autonomous-vehicle-passenger; and providing the assistance determined.

Providing the assistance in some implementations includes (a) delivering, by way of a vehicle-passenger interface, a vehicle message comprising instruction for performing a passenger task at the autonomous vehicle, and/or (b) delivering, by way of a vehicle-passenger interface, a vehicle message comprising instruction for passenger adjustment of a component of the autonomous vehicle.

In still another aspect, the disclosure relates to a process for implementation at an autonomous-driving vehicle of transportation, and obtaining, by a tangible human-machine interface, an autonomous-vehicle-passenger communication, and obtaining, by a hardware-based processing unit, context data comprising learned-passenger data based on prior activity of an autonomous-vehicle-passenger. The process further includes determining, by the hardware-based processing unit executing a passenger-informing module, based on the autonomous-vehicle-passenger speech communication and the context data, appropriate information to provide to the autonomous-vehicle-passenger, and delivering the information determined.

Other aspects of the present technology will be in part apparent and in part pointed out hereinafter.

### DESCRIPTION OF THE DRAWINGS

FIG. 1 illustrates schematically an example vehicle of transportation, with local and remote personal computing devices, according to embodiments of the present technology.

FIG. 2 illustrates schematically more details of the example vehicle computer of FIG. 1 in communication with the local and remote computing devices.

FIG. 3 shows another view of the vehicle, emphasizing example memory components.

FIG. 4 shows interactions between the various components of FIG. 3, including with external systems.

FIG. 5 shows schematically an example architecture for use in performing functions of the present technology.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

I. Technology Introduction

The present disclosure describes, by various embodiments, to vehicle systems for interacting efficiently with occupants and, more particularly, to systems for interacting intelligently with autonomous-vehicle passengers. In various embodiments, the technology involves determining passenger needs and preferences, and determining responsive actions including controlling autonomous vehicle functions or delivering instructions or explanations to the passenger by way of one or more vehicle or mobile-device human-machine interfaces (HMIs).

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, trucks, busses, manufacturing equipment (for example, forklift), construction machines, and agricultural machinery, or of warehouse equipment, devices at the office, home appliances, personal or mobile computing devices, such as phones, wearables, plug-ins, and wireless peripherals, the like, and other.

While select examples of the present technology describe autonomous vehicles, the technology is not limited to use in autonomous vehicles (fully or partially autonomous), or to times in which an autonomous-capable vehicle is being driven autonomously. References herein to characteristics of a passenger, and communications provided for receipt by a passenger, for instance, should be considered to disclose analogous implementations regarding a vehicle driver during manual vehicle operation. During fully autonomous driving, the ‘driver’ is considered a passenger.

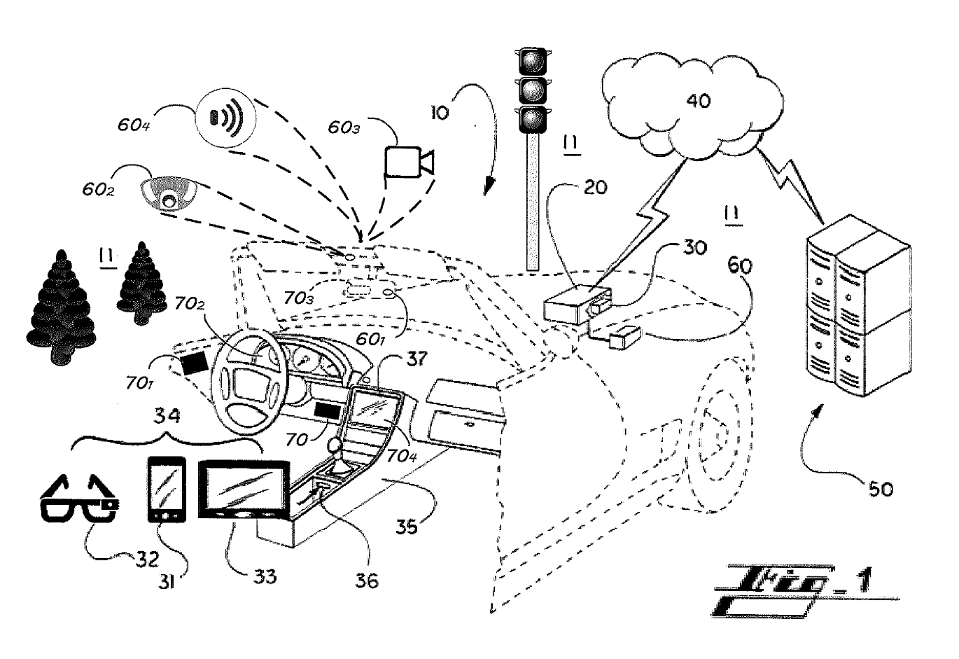

II. Host Vehicle—FIG. 1

Turning now to the figures and more particularly the first figure, FIG. 1 shows an example host structure or apparatus 10 in the form of a vehicle.

The vehicle 10 includes a hardware-based controller or controller system 20. The hardware-based controller system 20 includes a communication sub-system 30 for communicating with mobile or local computing devices 34 and/or external networks 40.

By the external networks 40, such as the Internet, a local-area, cellular, or satellite network, vehicle-to-vehicle, pedestrian-to-vehicle or other infrastructure communications, etc., the vehicle 10 can reach mobile or local systems 34 or remote systems 50, such as remote servers.

Example mobile or local devices 34 include a passenger smartphone 31, a passenger wearable device 32, and a USB mass storage device 33, and are not limited to these examples. Example wearables 32 include smart-watches, eyewear, and smart-jewelry, such as earrings, necklaces, and lanyards.

Another example mobile or local device is an on-board device (OBD) (not shown in detail), such as a wheel sensor, a brake sensor, an accelerometer, a rotor-wear sensor, throttle-position sensor, steering-angle sensor, revolutions-per-minute (RPM) indicator, brake-force sensors, other vehicle state or dynamics-related sensor for the vehicle, with which the vehicle is retrofitted with after manufacture. The OBD(s) can include or be a part of the sensor sub-system referenced below by numeral 60.

The vehicle controller system 20, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller 20 are in other embodiments executed via similar or other message-based protocol.

The vehicle 10 also has various mounting structures 35. The mounting structures 35 include a central console, a dashboard, and an instrument panel. The mounting structure 35 includes a plug-in port 36—a USB port, for instance—and a visual display 37, such as a touch-sensitive, input/output, human-machine interface (HMI).

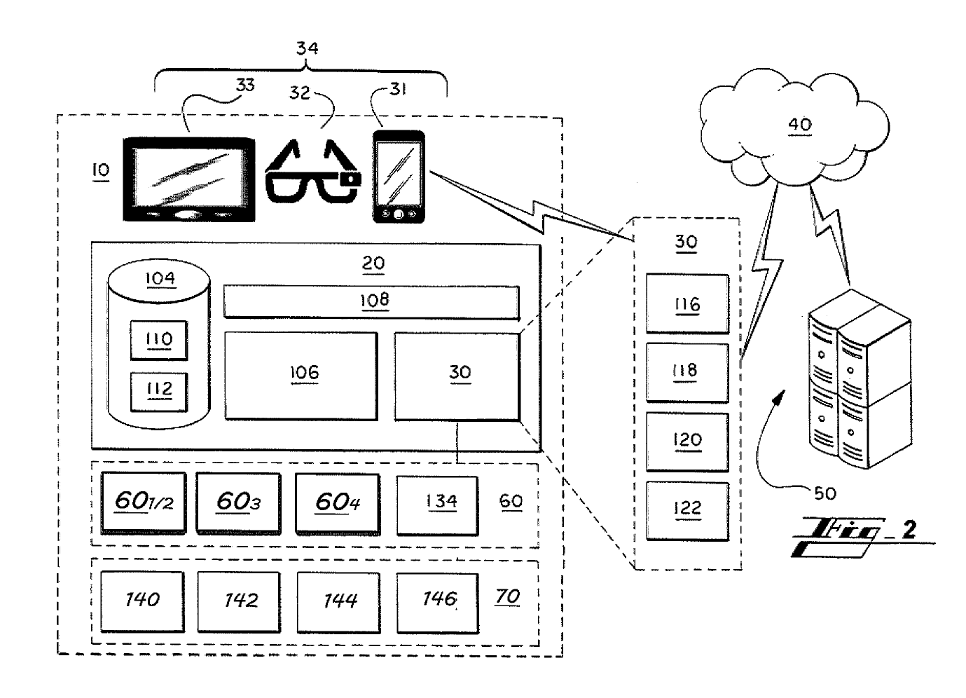

The vehicle 10 also has a sensor sub-system 60 including sensors providing information to the controller system 20. The sensor input to the controller 20 is shown schematically at the right, under the vehicle hood, of FIG. 2. Example sensors having base numeral 60 (60₁, 60₂, etc.) are also shown.

Sensor data relates to features such as vehicle operations, vehicle position, and vehicle pose, passenger characteristics, such as biometrics or physiological measures, and environmental-characteristics pertaining to a vehicle interior or outside of the vehicle 10.

Example sensors include a camera 60₁ positioned in a rear-view mirror of the vehicle 10, a dome or ceiling camera 60₂ positioned in a header of the vehicle 10, a world-facing camera 603 (facing away from vehicle 10), and a world-facing range sensor 604. Intra-vehicle-focused sensors 60₁, 60₂, such as cameras, and microphones, are configured to sense presence of people, activities or people, or other cabin activity or characteristics. The sensors can also be used for authentication purposes, in a registration or re-registration routine. This subset of sensors are described more below.

World-facing sensors 603, 604 sense characteristics about an environment 11 comprising, for instance, billboards, buildings, other vehicles, traffic signs, traffic lights, pedestrians, etc.

The OBDs mentioned can be considered as local devices, sensors of the sub-system 60, or both in various embodiments.

Local devices 34 (e.g., passenger phone, passenger wearable, or passenger plug-in device) can be considered as sensors 60 as well, such as in embodiments in which the vehicle 10 uses data provided by the local device based on output of a local-device sensor(s). The vehicle system can use data from a passenger smartphone, for instance, indicating passenger-physiological data sensed by a biometric sensor of the phone.

The vehicle 10 also includes cabin output components 70, such as sound speakers 701, and an instruments panel or display 702. The output components may also include dash or center-stack display screen 703, a rear-view-mirror screen 704 (for displaying imaging from a vehicle aft/backup camera), and any vehicle visual display device 37.

III. On-Board Computing Architecture—FIG. 2

FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The media can be a device, and can be non-transitory.

In various embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

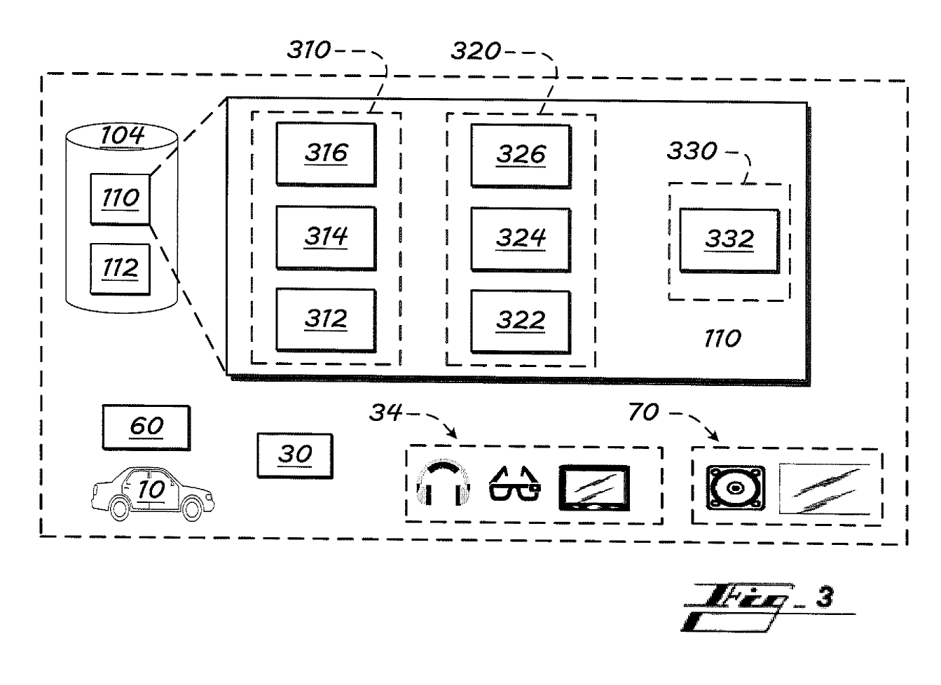

The data storage device 104 includes one or more storage modules 110 storing computer-readable code or instructions executable by the processing unit 106 to perform the functions of the controller system 20 described herein. The modules and functions are described further below in connection with FIGS. 3-5.

The data storage device 104 in various embodiments also includes ancillary or supporting components 112, such as additional software and/or data supporting performance of the processes of the present disclosure, such as one or more passenger profiles or a group of default and/or passenger-set preferences.

As provided, the controller system 20 also includes a communication sub-system 30 for communicating with local and external devices and networks 34, 40, 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in various embodiments configured to facilitate communications between the controller system 20 and a satellite and/or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controller system 20 can, by operation of the processor 106, send and receive information, such as in the form of messages or packetized data, to and from the communication network(s) 40.

Remote devices 50 with which the sub-system 30 communicates are in various embodiments nearby the vehicle 10, remote to the vehicle, or both.

The remote devices 50 can be configured with any suitable structure for performing the operations described herein. Example structure includes any or all structures like those described in connection with the vehicle computing device 20. A remote device 50 includes, for instance, a processing unit, a storage medium comprising modules, a communication bus, and an input/output communication structure. These features are considered shown for the remote device 50 by FIG. 1 and the cross-reference provided by this paragraph.

While local devices 34 are shown within the vehicle 10 in FIGS. 1 and 2, any of them may be external to the vehicle and in communication with the vehicle.

Example remote systems 50 include a remote server (for example, application server), or a remote data, customer-service, and/or control center. A passenger computing or electronic device 34, such as a smartphone, can also be remote to the vehicle 10, and in communication with the sub-system 30, such as by way of the Internet or other communication network 40.

An example control center is the OnStar® control center, having facilities for interacting with vehicles and passengers, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 comprising sensors providing information to the controller system 20 regarding items such as vehicle operations, vehicle position, vehicle pose, passenger characteristics, such as biometrics or physiological measures, and/or the environment about the vehicle 10. The arrangement can be configured so that the controller system 20 communicates with, or at least receives signals from sensors of the sensor sub-system 60, via wired or short-range wireless communication links 116, 120.

In various embodiments, the sensor sub-system 60 includes at least one camera and at least one range sensor 604, such as radar or sonar, directed away from the vehicle, such as for supporting autonomous driving.

Visual-light cameras 603 directed away from the vehicle 10 may include a monocular forward-looking camera, such as those used in lane-departure-warning (LDW) systems. Embodiments may include other camera technologies, such as a stereo camera or a trifocal camera.

Sensors configured to sense external conditions may be arranged or oriented in any of a variety of directions without departing from the scope of the present disclosure. For example, the cameras 603 and the range sensor 604 may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 604 may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include the mentioned cabin sensors (60₁, 60₂, etc.) configured and arranged (e.g., positioned and fitted in the vehicle) to sense activity, people, cabin environmental conditions, or other features relating to the interior of the vehicle. Example cabin sensors (60₁, 60₂, etc.) include microphones, in-vehicle visual-light cameras, seat-weight sensors, passenger salinity, retina or other passenger characteristics, biometrics, or physiological measures, and/or the environment about the vehicle 10.

The cabin sensors (60₁, 60₂, etc.), of the vehicle sensors 60, may include one or more temperature-sensitive cameras (e.g., visual-light-based (3D, RGB, RGB-D), infra-red or thermographic) or sensors. In various embodiments, cameras are positioned preferably at a high position in the vehicle 10. Example positions include on a rear-view mirror and in a ceiling compartment.

A higher positioning reduces interference from lateral obstacles, such as front-row seat backs blocking second- or third-row passengers, or blocking more of those passengers. A higher positioned camera (light-based (e.g., RGB, RGB-D, 3D, or thermal or infra-red) or other sensor will likely be able to sense temperature of more of each passenger's body—e.g., torso, legs, feet.

Two example locations for the camera(s) are indicated in FIG. 1 by reference numeral 60₁, 60₂, etc.—on at rear-view mirror and one at the vehicle header.

Other example sensor sub-systems 60 include dynamic vehicle sensors 134, such as an inertial-momentum unit (IMU), having one or more accelerometers, a wheel sensor, or a sensor associated with a steering system (for example, steering wheel) of the vehicle 10.

The sensors 60 can include any sensor for measuring a vehicle pose or other dynamics, such as position, speed, acceleration, or height—e.g., vehicle height sensor.

The sensors 60 can include any known sensor for measuring an environment of the vehicle, including those mentioned above, and others such as a precipitation sensor for detecting whether and how much it is raining or snowing, a temperature sensor, and any other.

Sensors for sensing autonomous-vehicle-passenger characteristics include any biometric sensor, such as a camera used for retina or other eye-feature recognition, facial recognition, or fingerprint recognition, a thermal sensor, a microphone used for voice or other passenger recognition, other types of passenger-identifying camera-based systems, a weight sensor, salinity sensor, breath-quality sensors (e.g., breathalyzer), a passenger-temperature sensor, electrocardiogram (ECG) sensor, Electrodermal Activity (EDA) or Galvanic Skin Response (GSR) sensors, Blood Volume Pulse (BVP) sensors, Heart Rate (HR) sensors, electroencephalogram (EEG) sensor, Electromyography (EMG), and passenger-temperature, a sensor measuring salinity level, the like, or other.

Passenger-vehicle interfaces, such as a touch-sensitive display 37, buttons, knobs, the like, or other can also be considered part of the sensor sub-system 60.

FIG. 2 also shows the cabin output components 70 mentioned above. The output components in various embodiments include a mechanism for communicating with vehicle occupants. The components include but are not limited to sound speakers 140, visual displays 142, such as the instruments panel, center-stack display screen, and rear-view-mirror screen, and haptic outputs 144, such as steering wheel or seat vibration actuators. The fourth element 146 in this section 70 is provided to emphasize that the vehicle can include any of a wide variety of other in output components, such as components providing an aroma or light into the cabin.

IV. Additional Vehicle Components—FIG. 3

FIG. 3 shows an alternative view of the vehicle 10 of FIGS. 1 and 2 emphasizing example memory components, and showing associated devices.

As mentioned, the data storage device 104 includes one or more modules 110 for performance of the processes of the present disclosure. and the device 104 may include ancillary components 112, such as additional software and/or data supporting performance of the processes of the present disclosure. The ancillary components 112 can include, for example, additional software and/or data supporting performance of the processes of the present disclosure, such as one or more passenger profiles or a group of default and/or passenger-set preferences.

Any of the code or instructions described can be part of more than one module. And any functions described herein can be performed by execution of instructions in one or more modules, though the functions may be described primarily in connection with one module by way of primary example. Each of the modules can be referred to by any of a variety of names, such as by a term or phrase indicative of its function.

Sub-modules can cause the processing hardware-based unit 106 to perform specific operations or routines of module functions. Each sub-module can also be referred to by any of a variety of names, such as by a term or phrase indicative of its function.

Example modules 110 shown include:
Input Group 310
   an input-interface module 312;
   a database module 314;
   a passenger-profile learning module 316;
Activity Group 320
   a passenger-speech vehicle-control module 322;
   a passenger-assistance module 324;
   a passenger-informing module 326; and
Output Group 330
   an output-interface module 332.

Other vehicle components shown in FIG. 3 include the vehicle communications sub-system 30 and the vehicle sensor sub-system 60. These sub-systems act at least in part as input sources to the modules 110, and particularly to the input interface module 302. Example inputs from the communications sub-system 30 include identification signals from mobile devices, which can be used to identify or register a mobile device, and so the corresponding passenger, to the vehicle 10, or at least preliminarily register the device/passenger to be followed by a higher-level registration.

Example inputs from the vehicle sensor sub-system 60 include and are not limited to:
bio-metric sensors providing bio-metric data regarding vehicle occupants, such as facial features, voice recognition, heartrate, salinity, skin or body temperature for each occupant, etc.;
vehicle-occupant input devices (human-machine interfaces (HMIs), such as a touch-sensitive screen, buttons, knobs, microphones, and the like;
cabin sensors providing data about characteristics within the vehicle, such as vehicle-interior temperature, in-seat weight sensors, and motion-detection sensors;
environment sensors providing data bout conditions about a vehicle, such as from external camera and distance sensors (e.g., LiDAR, radar); and
Sources separate from the vehicle 10, such as local devices 34, devices worn by pedestrians, other vehicle systems, local infrastructure (local beacons, cellular towers, etc.), satellite systems, and remote systems 34/50, providing any of a wide variety of information, such as passenger-identifying data, passenger-history data, passenger selections or passenger preferences contextual data (weather, road conditions, navigation, etc.), program or system updates—remote systems can include, for instance, applications servers corresponding to application(s) operating at the vehicle 10 and any relevant passenger devices 34, computers of a passenger or supervisor (parent, work supervisor), vehicle-operator servers, customer-control center system, such as systems of the OnStar® control center mentioned, or a vehicle-operator system, such as that of a taxi company operating a fleet of which the vehicle 10 belongs, or of an operator of a ride-sharing service.

The view also shows example vehicle outputs 70, and passenger devices 34 that may be positioned in the vehicle 10. Outputs 70 include and are not limited to:
vehicle speakers or audio output;
vehicle screens or visual output;
vehicle-dynamics actuators, such as those affecting autonomous driving (vehicle brake, throttle, steering);
vehicle climate actuators, such as those controlling HVAC system temperature, humidity, zone outputs, and fan speed(s); and
local devices 34 and remote systems 34/50, to which the system may provide a wide variety of information, such as passenger-identifying data, passenger-biometric data, passenger-history data, contextual data (weather, road conditions, etc.), instructions or data for use in providing notifications, alerts, or messages to the passenger or relevant entities such as authorities, first responders, parents, an operator or owner of a subject vehicle 10, or a customer-service center system, such as of the OnStar® control center.

The modules, sub-modules, and their functions are described more below.

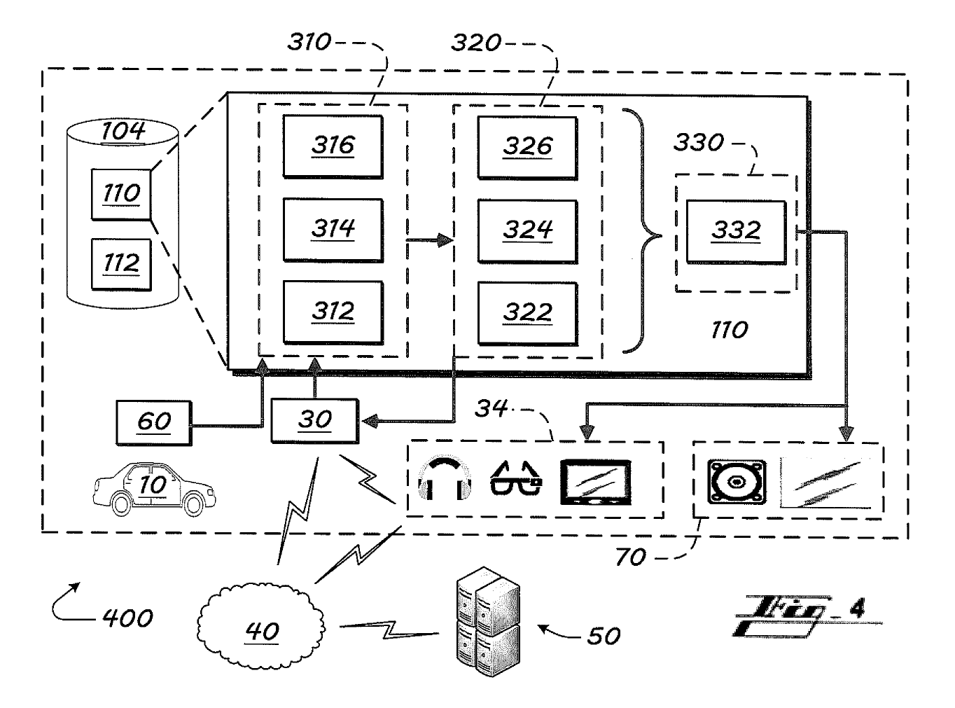

V. Algorithms and Processes—FIG. 4

V.A. Introduction to the Algorithms and Processes

FIG. 4 shows an example algorithm, represented schematically by a process flow 400, according to embodiments of the present technology. Though a single process flow is shown for simplicity, any of the functions or operations can be performed in one or more or processes, routines, or sub-routines of one or more algorithms, by one or more devices or systems.

It should be understood that the steps, operations, or functions of the processes 400 are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes 400 can be ended at any time.

In certain embodiments, some or all operations of the processes 400 and/or substantially equivalent operations are performed by a computer processor, such as the hardware-based processing unit 106, executing computer-executable instructions stored on a non-transitory computer-readable storage device, such as any of the data storage devices 104, or of a mobile device, for instance, described above.

V.B. System Components and Functions

FIG. 4 shows the components of FIG. 3 interacting according to various exemplary algorithms and process flows.

V.B.i. Input Group 310

The input group includes the input-interface module 312, the database module 314, and a passenger-profile learning module 316.

V.B.i.a. General Input Functions

The input module 312, executed by a processor such as the hardware-based processing unit 106, receives any of a wide variety of input data or signals, including from the sources described in the previous section (IV.). Inputs sources include vehicle sensors 60 and local or remote devices 34, 50 via the vehicle communication sub-system 30. Inputs also include a vehicle database, via the database module 304.

Data received can include, for instance, passenger profile data indicating preferences and historic activity of an autonomous-vehicle passenger or passengers.

Data received is stored at the memory 104 via the database module 314.

V.B.i.b. Learning Functions

The passenger-profile learning module 316 uses any of a wide variety of inputs to determine system output. The passenger-profile learning module 316 is configured to personalize the system to one or more passengers.

Passenger characteristics that can be learned include and are not limited to passenger-preferred driving style, routing, infotainment settings, HVAC settings, etc.

The configuration of the passenger-profile learning module 316 in various embodiments includes artificial intelligence, computational intelligence heuristic structures, or the like. Inputs can include data indicating present, or past or prior, passenger behavior, for instance.

Prior activity can include past actions of the passenger, in a prior ride in the vehicle 10 or another vehicle, such as statements from the passenger, questions from the passenger, or vehicle-control actions, as a few examples.

If an autonomous-vehicle passenger asks the vehicle to slow down on repeated occasions while driving near the speed limit on city roads, the passenger-profile learning module 316, having access to historic data indicating the requests, can deduce a passenger preference for a slower speed for autonomous city driving. Data indicating the new association is stored in the memory 104 via the database module 314, and the system can implement the preference on future occasions.

Output from the passenger-profile learning module 316 can be used as input to the modules of the activity group 320. For instance, if on repeated occasions an autonomous-vehicle passenger utters, “oh boy, these cars are moving fast” while the vehicle is traveling in a middle or left lane on a highway, but does not request deceleration, and then asks the vehicle to move lanes to the right, the passenger-profile learning module 316 can deduce that such passenger utterances are indicators that the passenger feels safer when traveling in the right lane in highway driving, or when farther to the right, generally.

Data from the passenger-profile learning module 316 indicating the new association is stored in the memory 104 via the database module 314. When the system later detects such utterance while driving in the middle or farther left lane, the system—i.e., the passenger-speech vehicle-control module 322—can use the stored association to interpret the utterance to identify the underlying passenger need, and so control the autonomous vehicle accordingly—i.e., move one or more lanes rightward.

Or the learning module may determine that the such utterance is provided with the context of the vehicle driving adjacent a small shoulder having a ditch on the opposite side, and/or on separate occasions with the context of being in a lane closest to a rail of a bridge, and so determine that the passenger is not comfortable with heights, or at least with driving relatively close to small shoulders, ditches, or bridge rales, for instance.

By the learning functions, the vehicle is customized better to the passenger, and the passenger experience is improved for various reasons. The passenger is more comfortable, and experience less or no stress, as the vehicle makes more maneuvers and decisions based on determined passenger preferences. The passenger is also relieved of having to determine how to advise the vehicle that the passenger wants the vehicle to make the maneuver that would make them feel more comfortable. They need not, for instance, consider which button to press, or which pre-set control wording to say (e.g., “car, please change lanes to the right”).

In a contemplated embodiment, passenger-profile learning module 316 is also configured to make associations between other passenger behavior, such as gestures, and passenger desires or preferences. A user sighing deeply, or covering their eyes with a hand, sensed by a vehicle interior camera, can be interpreted to express stress and, based on the circumstance, an implicit desire to change the situation, such as by changing lane rightward. The associated activity 322 can be referred to by another name in this case, such as passenger-input vehicle-control module, or one or more other modules (passenger-gestures module, passenger-behaviors module, passenger-utterances module) or sub-modules can be provided to perform these functions.

V.B.i.c. Input Functions Summary

In various embodiments, the system is configured to receive and store passenger preferences provided to the system expressly by the passenger.

The profile for each passenger can include passenger-specific preferences communicated to the system by the passenger, such as via a touch-screen or microphone interface.

All or select components of the passenger profile can be stored at the memory 104 via the database module 314, and at other local or remote devices, such as at a user device 34, or customer-service center computer or server 50.

Input group modules can interact with each other in a variety of ways. Output of the input and learning modules may be stored via the database module, for instance, and the learning module considers data from the database module.

Input-group data is passed on, after any formatting, conversion, or other processing at the input module 302, to the activity group 320.

V.B.ii. Activity Group 320

Turning further to the activity group 320, the modules of the group determine manners to interact with the user, such as via dialogue, and control vehicle functions, based on user input and context. Context data can indicate any of a wide variety of factors, such as a present vehicle state or mode, present autonomous-driving operations conditions (speed, route, etc.), weather, road conditions, or other.

The primary user input described herein includes speech or other verbal input, including utterances. The technology is not limited to using verbal input, however, as referenced above.

V.B.ii.a. Vehicle-Control Functions

The passenger-speech vehicle-control module 322 determines manners to adjust vehicle functions based on passenger speech, or verbal, input, and any available and applicable context data. The system is configured to determine appropriate output in response to any of a wide variety of passenger inputs, including passenger questions, statements, and utterances.

As mentioned, the passenger-speech vehicle-control module 322, or another one or more modules can also be configured to translate user communication or behavior other than verbal communications to passenger desire or appropriate system response. The translation can be based on circumstances indicated at least in part by context data.

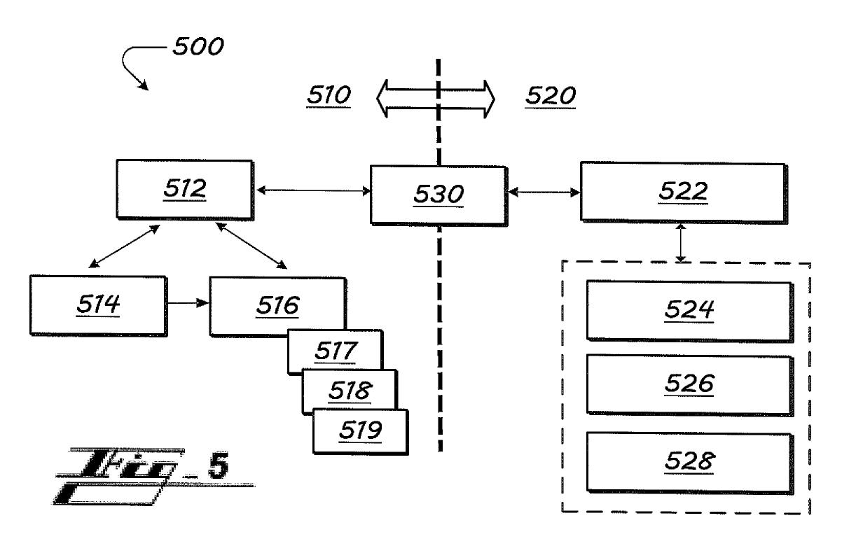

Context data can be received at any module from the system memory 104, by way of the database module 314, vehicle sensors 60, or from a local or remote source 34, 50, by way of the communication sub-system 30 and input module 312, for instance. The context data is in various embodiments received from a vehicle context manager 516 (FIG. 5).

For embodiments in which the system performs learning functions, the passenger-speech vehicle-control module 322 processes as input results of the learning. This input can be received from various sources, such as directly from the passenger-profile learning module 316, from the memory 104 via the database module 314, or from a local or remote source 34, 50 if learning-based data is stored at those locations. The learning-based data is in various embodiments considered as context data.

In various embodiments, vehicle functions controlled include autonomous-driving functions and internal-vehicle functions. The passenger-speech vehicle-control module 322 controls autonomous-driving functions by way of vehicle automation systems, which include are in communication with vehicle-dynamic actuators, such as a vehicle throttle component, a vehicle-steering component, and a vehicle-braking component.

Controllable interior vehicle functions include a vehicle HVAC system, a vehicle infotainment system (channel settings and preferences, volume preference, time for using various apps, etc.), seat position system, window or moon-roof system, the like, and other. The passenger-speech vehicle-control module 322 may determine based on context data (e.g., cabin and/or external temperature) and user speech (e.g., “phyew!” or “it's hot”) that the passenger would feel more comfortable is the windows were rolled down a few inches, such as based on context, or the HVAC temperature turned down.

In various embodiments the passenger-speech vehicle-control module 322 is configured to dialogue with the passenger under certain circumstances. The passenger-speech vehicle-control module 322 may dialogue with the user to learn more information for determining a present vehicle-control function to perform, for instance. Passenger responses can also be used in learning functions. The passenger-profile learning module 316 can perform these operations, or the passenger-speech vehicle-control module 322 and the passenger-profile learning module 316 can work together for these operations.

Additional example vehicle-control scenarios (×5):
1) David is riding along the freeway
   a) David: “Please do not change lanes”
   b) Vehicle: “Got it. We will only change lanes if imperative.”
2) Laura is riding along the freeway, the vehicle indicates left
   a) Laura: “Don't take this turn”
   b) Vehicle: “Okay, generating a new route”
   c) Or, vehicle: “Sorry, safety first, I have to complete the left turn”
3) Laura is traveling autonomously, the vehicle indicates left
   a) Laura: “No. stay in this lane”
   b) Vehicle: “Okay, staying in this lane”
   c) Or, Vehicle: “Okay, staying in this lane, can you tell me why?”
   d) Laura: “I want a relaxed drive”
4) Laura is driving along the freeway
   a) Laura: “Change lane when possible” (or use turn signal)
   b) Vehicle: “Okay, will move to the left lane when possible”
5) Laura is driving along the freeway
   a) Laura: “I'd like to visit the financial district”
   b) Vehicle: “Okay. Adding a waypoint to your route now.”

V.B.ii.b. Passenger-Assistance Functions

The passenger-assistance module 324 determines, based on context and user input, appropriate vehicle actions to perform for assisting the passenger.

The passenger-assistance module 324 determines the appropriate actions based on passenger speech, or verbal, input, and any available and applicable context data. The system is configured to determine appropriate actions in response to any of a wide variety of passenger inputs, including passenger questions, statements, and utterances.

The passenger-assistance module 324 can also be configured to translate user communication or behavior other than verbal communications to passenger desire or appropriate system response. The translation can be based on circumstances indicated at least in part by context data.

Context data can be received at any module from the system memory 104, by way of the database module 314, vehicle sensors 60, or from a local or remote source 34, 50, by way of the communication sub-system 30 and input module 312, for instance. The context data is in various embodiments received from a vehicle context manager 516 (FIG. 5).

For embodiments in which the system performs learning functions, the passenger-assistance module 324 processes as input results of the learning. This input can be received from various sources, such as directly from the passenger-profile learning module 316, from the memory 104 via the database module 314, or from a local or remote source 34, 50 if learning-based data is stored at those locations. The learning-based data is in various embodiments considered as context data.

Example assistance provided to the passenger via the passenger-assistance module 324 includes instructions on how to accomplish specific passenger goals in or at the vehicle. If the passenger does not know how to open the hood of the vehicle 10, for instance, the passenger-assistance module 324 can instruct the user by vehicle voice output how to open the hood.

Passenger-assistance instruction can be provided by the passenger-assistance module 324 in response to a variety of inputs, such as express user question (e.g., “how do I open the hood”), or by indirect user communication, such as the user stating, “Ugh, I don't know how to do this,” interpreted to relate to hood opening based also on context data indicating that the vehicle needs a battery boost.

In a contemplated embodiment, the passenger-assistance module 324 also includes adjusting vehicle systems, such as by unlocking the hood.

Data indicating passenger reaction to assistance provided can be stored, at the memory 104 via the database module 314, or shared with local or remote systems 34, 50. The data can also be used in the learning functions, for improving system reaction in a present and/or any future scenarios.

As with the other activity-group modules 320, in various embodiments the passenger-assistance module 324 is configured to dialogue with the passenger under certain circumstances. The passenger-assistance module 324 may dialogue with the user to learn more information for determining a present manner by which to assist the passenger. Passenger responses can also be used in learning functions. The passenger-profile learning module 316 can perform these operations, or the passenger-assistance module 324 and the passenger-profile learning module 316 can work together for these operations.

Additional example vehicle-assistance scenarios (×7):
1) Laura would like to access the vehicle trunk
   a) Laura: “How do I open the trunk?”
      [The system is configured in various embodiments to respond to a name or other passenger indication that the passenger is calling upon the vehicle. The system is configured to allow the user to set the name or indication. If the user has chosen to identify the vehicle as Emma, for instance, the statement above could be, then, “Emma, “How do I open the trunk?”
   b) Vehicle: “Oh, let me just open it for you. And if you prefer the next time you will find the button on the left side of the steering wheel.” (And, vehicle screen 37 can show the button with icon and its environment)
2) Laura would like to change routing
   a) Laura: “How do I add a destination?”
   b) Vehicle: “You can just say “I want to add a destination” or use “add destination” in your navigation app. Would you like to add a new destination now?
3) Laura would like to have vehicle automatically unlock upon her approach
   a) Laura: “How do I set my lock to unlock when I approach the car?”
   b) Vehicle: (Provides step-by-step instructions, walking her through the steps)
4) Following a car incident
   a) Laura: “What should I do?”
   b) Vehicle: (Provides step-by-step instructions, walking her through the steps. E.g., “slow down and find a safe place with margin from the road to stop, (etc.)”
   c) Laura: (Interacts with vehicle if she desires—e.g., “Okay, I pulled over, now what?” Or the vehicle can proactively provide next steps when performance of the prior step is determinable automatically, such as pulling over and stopping. Some activities are not easily determinable by the vehicle automatically, such as Emma providing her insurance card to the other driver may not be determinable, and so vehicle-passenger dialogue be performed to trigger continued instruction).
5) Laura is driving semi-autonomously in town, looking for parking
   a) Laura: “Can I park here?”
   b) Vehicle: “There's a good parking spot 30 yards ahead.”
6) Destination cases that have urgency
   a) Laura: “Emma, stop right here”
   b) Vehicle: “Ok, I'll stop as soon as I can”
7) Laura seeks assistance with vehicle infotainment
   a) Laura: “Emma, can I connect my phone to display at your screen?”
   b) Vehicle: “Yes, connecting now . . . ”

V.B.ii.c. Passenger-Informing Functions

The passenger-informing module 326 determines, based on context and user input, appropriate explanatory information to provide to the passenger.

The passenger-informing module 326 determines appropriate information to provide to the passenger about vehicle functions based on passenger speech, or verbal, input, and any available and applicable context data. The system is configured to determine appropriate information about vehicle functions in response to any of a wide variety of passenger inputs, including passenger questions, statements, and utterances.

The passenger-informing module 326 can also be configured to translate user communication or behavior other than verbal communications to passenger desire or appropriate system response. The translation can be based on circumstances indicated at least in part by context data.

Context data can be received at any module from the system memory 104, by way of the database module 314, vehicle sensors 60, or from a local or remote source 34, 50, by way of the communication sub-system 30 and input module 312, for instance. The context data is in various embodiments received from a vehicle context manager 516 (FIG. 5).

For embodiments in which the system performs learning functions, the passenger-informing module 326 processes as input results of the learning. This input can be received from various sources, such as directly from the passenger-profile learning module 316, from the memory 104 via the database module 314, or from a local or remote source 34, 50 if learning-based data is stored at those locations. The learning-based data is in various embodiments considered as context data.

Example information provided to the passenger via the passenger-informing module 326 includes information explaining an autonomous-driving maneuver that the vehicle 10 recently performed, is currently performing, or is about to perform. If the user asks, “why did we slow down?”, for instance, the passenger-informing module 326 determines an appropriate explanation, such as, “We are approaching your destination,” or “there was a large pothole that we avoided.”

Information can be provided to the passenger by the passenger-informing module 326 in response to a variety of inputs, such as express user question (e.g., “why are we turning”), or by indirect user communication, such as the user stating, “what?!?”, or “what happened”, interpreted to relate to a maneuver just performed based also on context data indicating that the vehicle made a relatively short-radius turn at a relatively high speed to get out of the way of an approaching emergency vehicle. The vehicle 10 may have determined that the emergency vehicle was approaching based on V2V (e.g., DSRC) or V2I communications, for instance.

Data indicating passenger reaction to information provided can be stored, at the memory 104 via the database module 314, or shared with local or remote systems 34, 50. The data can also be used in the learning functions, for improving system determinations of information to provide, or for improving other system reactions (e.g., assistance functions), in a present and/or any future scenarios.

As with the other activity-group modules 320, in various embodiments the passenger-informing module 326 is configured to dialogue with the passenger under certain circumstances. The passenger-informing module 326 may dialogue with the user to learn more information for determining present information to provide to the passenger, or a present manner by which to assist the passenger. Passenger responses can also be used in learning functions. The passenger-profile learning module 316 can perform these operations, or the passenger-informing module 326 and the passenger-profile learning module 316 can work together for these operations.

V.B.iii. Output Group 330

The output-interface module 332 formats, converts, or otherwise processes output of the activity module 306 prior to delivering same to the various output components.

As shown, example system output components include vehicle speakers, screens, or other vehicle outputs 70.

Example system output components can also include passenger mobile devices 34, such as smartphones, wearables, and headphones.

Example system output components can also include remote systems 50 such as remote servers and passenger computer systems (e.g., home computer). The output can be received and processed at these systems, such as to update a passenger profile with a determined preference, activity taken regarding the passenger, the like, or other.

Example system output components can also include a vehicle database. Output data can be provided to the database module 304, for instance, which can store such updates to an appropriate passenger account of the ancillary data 112.

VI. Example Architecture

FIG. 5 shows schematically an example architecture 500 for use in performing functions of the present technology.

The architecture 500 includes:
a context-and-output portion 510;
an action-determination portion 520;
an interface 512, including a human-machine interface (HMI) for interacting with the passenger(s), and the same or other interface for communicating with the action-determination portion 520, and the same or other interface for communicating with other devices, such as with local or remote devices 34, 50 [the interface 512 can include or be connected to the communications sub-system 30, for instance];
vehicle automation systems 514, including autonomous driving components;
a context manager 516, mentioned above, and in the U.S. patent application from which the present disclosure claims priority. In various embodiments the manager 516 provides context to support operation of any of the modules described above, including passenger-assistance structure 517, for passenger-assistance structure functions, vehicle-control structure 518, for vehicle-control functions, and informational structure 519, for autonomous-vehicle passenger informing functions.
Speech recognition structure 522, including or operating in connection with:
   a dynamic grammar generator 524;
   a dynamic intent classifier generator 526; and
   a dynamic dialog generator 528.

The action-determination portion 520 is in various embodiments, (a) positioned in the vehicle 10 with the context-and-output portion 510, (b) positioned at a separate location, such as by residing at a remote server 50, or (c) partially local to the vehicle 10 and partially remote.

The portions 510, 520 are in various embodiments connected by a suitable API 530.

Most of these features are described in the U.S. patent application from which the present disclosure claims priority, and so not described further here.

VII. Select Advantages

Many of the benefits and advantages of the present technology are described above. The present section restates some of those and references some others. The benefits described are not exhaustive of the benefits of the present technology.

Passenger experience in an automated vehicle fitted with the present technology is vastly improved. For instance, the passenger can affect vehicle autonomous driving functions by simple statements, or in some embodiments even by utterances or gestures.

Similarly, the user can easily affect other vehicle operations, such as HVAC and infotainment functions.

The passenger can also obtain verbal assistance, supported by visual aid in some instances, with any of a wide variety of tasks that that the passenger desires or could use assistance with, such as changing a tire, programming a vehicle clock or navigation system, for instance.

The passenger can also obtain verbal information, with visual in some instance, that is determined by the vehicle system to be desired or likely helpful to the passenger, such as regarding vehicle operations. The system can advise the passenger about an autonomous-driving maneuver recently performed, presently being performed, or about to be performed, for instance, such as in response to a passenger inquiry—E.g., Autonomous-vehicle passenger: “Why are we going this way?”/Vehicle: “There was just an accident a block over on your usual route.”).

As another example benefit, by the learning functions, the vehicle is customized better to the autonomous-vehicle passenger, and the passenger experience is improved for various reasons. The passenger is more comfortable, and experience less or no stress, as the vehicle makes more maneuvers and decisions based on determined passenger preferences. The autonomous-vehicle passenger is also relieved of having to determine how to advise the vehicle that the passenger wants the vehicle to make the maneuver that would make them feel more comfortable. They need not, for instance, consider which button to press, or which pre-set control wording to say (e.g., “car, please change lanes to the right”).

The technology in operation enhances autonomous-vehicle passenger satisfaction, including comfort, with using automated driving by adjusting any of a wide variety of vehicle and/or non-vehicle characteristics, such as vehicle driving-style parameters.

The technology will lead to increased automated-driving system use. Passengers are more likely to use or learn about more-advanced autonomous-driving capabilities of the vehicle as well.

A ‘relationship’ between the passenger(s) and a subject vehicle can be improved—the passenger will consider the vehicle as more of a trusted tool, assistant, or friend.

The technology can also affect levels of adoption and, related, affect marketing and sales of autonomous-driving-capable vehicles. As passengers' trust in autonomous-driving systems increases, they are more likely to purchase an autonomous-driving-capable vehicle, purchase another one, or recommend, or model use of, one to others.

Another benefit of system use is that users will not need to invest effort in setting or calibrating automated driver style parameters, as they are set or adjusted automatically by the system, to minimize user stress and therein increase user satisfaction and comfort with the autonomous-driving vehicle and functionality.

VIII. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

References herein indicating direction are not made in limiting senses. For example, references to upper, lower, top, bottom, or lateral, are not provided to limit the manner in which the technology of the present disclosure can be implemented. While an upper surface may be referenced, for example, the referenced surface need not be vertically upward, in a design, manufacture, or operating reference frame, or above any other particular component, and can be aside of some or all components in design, manufacture and/or operation instead, depending on the orientation used in the particular application.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface is referenced, for example, the referenced surface can, but need not be vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A process, for implementation at an autonomous-driving vehicle of transportation, comprising:
obtaining, by a tangible human-machine interface, an autonomous-vehicle-passenger communication;
obtaining, by a hardware-based processing unit, context data comprising learned-passenger data based on prior activity of an autonomous-vehicle-passenger;
determining, by the hardware-based processing unit executing a passenger-communication vehicle-control module, based on the autonomous-vehicle-passenger communication and the context data, an appropriate autonomous-driving function; and
performing the autonomous-driving function.

2. The process of claim 1, wherein the autonomous-vehicle-passenger communication comprises at least one of:
autonomous-vehicle-passenger speech;
an autonomous-vehicle-passenger utterance; and
an autonomous-vehicle-passenger gesture.

3. The process of claim 1, wherein performing the autonomous-driving function comprises adjusting operation of one or more of:
a vehicle braking component;
a vehicle steering component; and
a vehicle throttle component.

4. The process of claim 1, further comprising:
obtaining, by the hardware-based processing unit, prior-passenger-activity data indicating the prior activity of the autonomous-vehicle passenger; and
generating, by the hardware-based processing unit, based on the prior-passenger-activity data, the learned-passenger data.

5. The process of claim 4, wherein the prior-passenger-activity data indicates autonomous-vehicle-passenger speech sensed at the vehicle in connection with an autonomous-vehicle maneuver performed by the autonomous-driving vehicle on a prior trip.

6. The process of claim 4, wherein the prior-passenger-activity data indicates an autonomous-vehicle-passenger response to an autonomous-vehicle maneuver made by the autonomous-driving vehicle on a prior trip.

7. The process of claim 4, wherein the prior-passenger-activity data indicates an autonomous-vehicle-passenger utterance sensed at the vehicle in connection with an autonomous-vehicle maneuver made by the autonomous-driving vehicle on a prior trip.

8. The process of claim 4, wherein the prior-passenger-activity data indicates an autonomous-vehicle-passenger gesture sensed in connection with an autonomous-vehicle maneuver performed by the autonomous-driving vehicle on a prior trip.

9. A process, for implementation at an autonomous-driving vehicle of transportation, comprising:
obtaining, by a tangible human-machine interface, an autonomous-vehicle-passenger communication;
obtaining, by a hardware-based processing unit, context data comprising learned-passenger data based on prior activity of an autonomous-vehicle-passenger;
determining, by the hardware-based processing unit executing a passenger-assistance module, based on the autonomous-vehicle-passenger communication and the context data, appropriate assistance to provide to the autonomous-vehicle-passenger; and
providing the assistance determined.

10. The process of claim 9, wherein the autonomous-vehicle-passenger communication comprises at least one of:
autonomous-vehicle-passenger speech;
an autonomous-vehicle-passenger utterance; and
an autonomous-vehicle-passenger gesture.

11. The process of claim 9, wherein providing the assistance comprises delivering, by way of a vehicle-passenger interface, a vehicle message comprising instruction for performing a passenger task at the autonomous vehicle.

12. The process of claim 9, wherein providing the assistance comprises delivering, by way of a vehicle-passenger interface, a vehicle message comprising instruction for passenger adjustment of a component of the autonomous vehicle.

13. The process of claim 9, further comprising:
obtaining, by the hardware-based processing unit, prior-passenger-activity data indicating the prior activity of the autonomous-vehicle passenger; and
generating, by the hardware-based processing unit, based on the prior-passenger-activity data, the learned-passenger data.

14. The process of claim 13, wherein the prior-passenger-activity data indicates autonomous-vehicle-passenger speech sensed at the vehicle in connection with an autonomous-vehicle maneuver performed by the autonomous-driving vehicle on a prior trip.

15. The process of claim 13, wherein the prior-passenger-activity data indicates an autonomous-vehicle-passenger response to an autonomous-vehicle maneuver made by the autonomous-driving vehicle on a prior trip.

16. The process of claim 13, wherein the prior-passenger-activity data indicates an autonomous-vehicle-passenger utterance sensed at the vehicle in connection with an autonomous-vehicle maneuver made by the autonomous-driving vehicle on a prior trip.

17. The process of claim 13, wherein the prior-passenger-activity data indicates an autonomous-vehicle-passenger gesture sensed in connection with an autonomous-vehicle maneuver performed by the autonomous-driving vehicle on a prior trip.

18. A process, for implementation at an autonomous-driving vehicle of transportation, comprising:
obtaining, by a tangible human-machine interface, an autonomous-vehicle-passenger communication;
obtaining, by a hardware-based processing unit, context data comprising learned-passenger data based on prior activity of an autonomous-vehicle-passenger;
determining, by the hardware-based processing unit executing a passenger-informing module, based on the autonomous-vehicle-passenger speech communication and the context data, appropriate information to provide to the autonomous-vehicle-passenger; and
delivering the information determined.

19. The process of claim 18, further comprising:
obtaining, by the hardware-based processing unit, prior-passenger-activity data indicating the prior activity of the autonomous-vehicle passenger; and
generating, by the hardware-based processing unit, based on the prior-passenger-activity data, the learned-passenger data.

20. The process of claim 19, wherein the prior-passenger-activity data indicates one or more of:
autonomous-vehicle-passenger speech sensed at the vehicle in connection with an autonomous-vehicle maneuver performed by the autonomous-driving vehicle on a prior trip;
an autonomous-vehicle-passenger response to an autonomous-vehicle maneuver made by the autonomous-driving vehicle on a prior trip;
an autonomous-vehicle-passenger utterance sensed at the vehicle in connection with an autonomous-vehicle maneuver made by the autonomous-driving vehicle on a prior trip; and
autonomous-vehicle-passenger gesture sensed in connection with an autonomous-vehicle maneuver performed by the autonomous-driving vehicle on a prior trip.
